(19) United States
(12) Patent Application Publication
(10) Pub. No.: US 2007/0247755 A1
(43) Pub. Date: Oct. 25, 2007

(54) SLIDER DEVICE, SYSTEM AND METHOD

(76) Inventors: ALLEN MING-KUANG HAN, Snoqualmie, WA (US); Joshua D. Hug, Seattle, WA (US)

Correspondence Address: HOLLAND & KNIGHT LLP, 10 ST. JAMES AVENUE, BOSTON, MA, 02116, US

(21) Appl. No.: 11/624,899

(22) Filed: Jan. 19, 2007

Related U.S. Application Data
(60) Provisional application No. 60/760,531, filed on Jan. 20, 2006.

(51) Int. Cl. G06F 17/00

(52) U.S. Cl. 360/128

(57) ABSTRACT

A slider device includes a tab capable of movement in a first linear direction and a second linear direction. A first spring and second spring are each disposed adjacent the tab. The first and second springs are capable of biasing the tab into a biased position. The first spring is further capable of providing mechanical resistance to the movement of the tab in the first linear direction and the second spring is capable of providing mechanical resistance to the movement of the tab in the second linear direction. An electric circuit is coupled with the tab and operative to generate a first signal comprising information corresponding to an distance of movement of the tab in the first linear direction and a second signal comprising additional information related to a distance of movement of the tab in the second linear direction.

### RELATED APPLICATION

This application is a utility conversion of the following provisional application, which is herein incorporated by reference: U.S. Provisional Ser. No. 60/760,531; filed 20 Jan. 2006, entitled: SLIDER DEVICE, SYSTEM AND METHOD.

### TECHNICAL FIELD

The present disclosure relates to a slider device, system and method.

### BACKGROUND

Media distribution systems (e.g., the Rhapsody™ service offered by RealNetworks, Inc., of Seattle, Wash.) distribute media content to a user's electronic device from a media server. A media distribution system may distribute media data files by allowing a user to download media data files and/or receive and process media data streams. The user's electronic device may allow the user to control playback and/or other functions associated with the media data files.

Typically, when a user wishes to play (i.e., render) a particular track, the user may select the desired track for playback using controls included within the user's electronic device. Unfortunately, as the number of tracks stored on the user's electronic device increases, the process of selecting the appropriate track for playback may require that the user scroll through long lists of tracks and, therefore, may become overly cumbersome/burdensome.

### SUMMARY OF DISCLOSURE

In a first implementation, a slider device includes a tab capable of movement in a first linear direction and a second linear direction. A first spring and second spring are each disposed adjacent the tab. The first and second springs are capable of biasing the tab into a biased position. The first spring is further capable of providing mechanical resistance to the movement of the tab in the first linear direction and the second spring is capable of providing mechanical resistance to the movement of the tab in the second linear direction. An electric circuit is coupled with the tab and operative to generate a first signal comprising information corresponding to an distance of movement of the tab in the first linear direction and a second signal comprising additional information corresponding to an distance of movement of the tab in the second linear direction.

### BRIEF DESCRIPTION OF THE DRAWINGS

FIG. 1 illustrates an exemplary system embodiment;

FIG. 2 is a block diagram of the personal media device of FIG. 1;

FIG. 3 illustrates one view an exemplary slider device;

FIG. 4 illustrates another view of the exemplary slider device;

FIGS. 5A and 5B depict signals generated by the exemplary slider device; and

FIG. 6 depicts a flowchart of exemplary operations according to one embodiment.

### DETAILED DESCRIPTION OF EXEMPLARY EMBODIMENTS

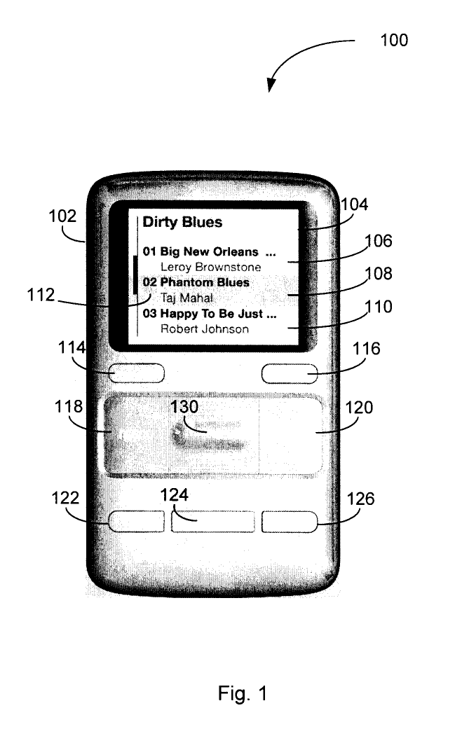

FIG. 1 illustrates a system embodiment 100 of the claimed subject matter. The system 100 may generally include personal media device 102. Personal media device 102 may store media data and permit a user (not shown) to play media data. Personal media device 102 may receive and store media content from a media distribution system (not shown) such as, for example, the Rhapsody™ media service offered by RealNetworks, Inc. of Seattle, Wash.

Examples of personal media device 102 may include, but are not limited to, a personal music/video device (e.g., Item 102, FIG. 1), a personal computer (not shown), a laptop computer (not shown), a personal digital assistant (not shown), a cellular telephone (not shown), a television (not shown), a cable box (not shown), an internet radio (not shown), a dedicated network device (not shown), a gaming system (not shown), and/or an AM/FM/satellite radio (not shown), for example.

The media content may be, for example, digitally-encoded audio and/or video data that is compressed using known compression techniques. The media content may be in the form of audio (e.g., music speech), text, pictures, and/or video, examples of which include but are not limited to the streaming of music, radio broadcasts, movies, television/cable broadcasts, and sporting events, for example.

Examples of the known compression techniques include various MPEG (i.e., Motion Picture Experts Group) standards, such as MPEG1, MPEG2 (Part 3) and MPEG4, H.263 (i.e., a video encoding/decoding algorithm), H.264 (i.e., a video encoding/decoding algorithm), Advanced Audio Coding, and for example other techniques promulgated by the International Standards Organization (ISO) or such other organizations such as the Motion Picture Experts Group.

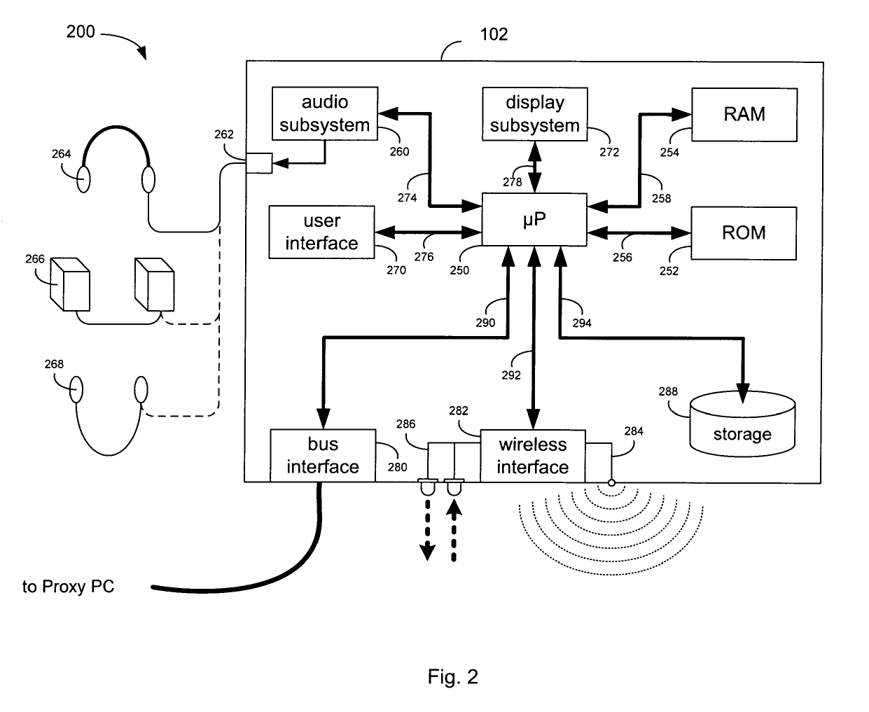

Personal media device 102 may include a display panel/device 104 configured to display media information related to media content stored on device 102. For example, personal media device 102 may be capable of displaying media information in the form of the title and artist of one or more media content items 106, 108, 110 stored in a memory 252 or 254 (FIG. 2) within personal media device 102. Personal media device 102 may also include a slider device 130 that may be used to scroll upward or downward through the list of media content stored within personal media device 102 (by the respective upward or downward movement of slider device 130) in relation to a visual indicator highlight bar 112. When the desired piece of media content is highlighted (e.g., “Phantom Blues” by “Taj Mahal”), a user may select the media content for rendering (i.e., “playback”) by depressing he slider device 130. When rendering visual highlight bar 112, the background of the text and/or the text itself within visual highlight bar 112 may be rendered using color(s) that contrast the background color and/or text color outside of visual highlight bar 112. For example, the area inside of visual highlight bar 112 is shown to include tan/dark gray text and a light gray background, while the area outside of the highlight bar is shown to include black/dark gray text and a white background.

Personal media device 102 may also include: rating switches 114, 116; skip backward switch 122; play/pause switch 124; and skip forward switch 126. Skip backward switch 122 may permit the user to skip backward to the previous piece of media content (e.g., “Big New Orleans . . . ” by “Leroy Brownstone”). Conversely, skip forward switch 126 may permit the user to skip forward to the next piece of media content (e.g., “Happy To Be Just . . . ” by “Robert Johnson”). Rating switches 114 and/or 116 may allow a user to rate the media content they are listening to on personal media device 102.

FIG. 2 depicts a block diagram 200 of the personal media device 102. Personal media device 12 may include a microprocessor 250 (e.g., an ARM™ microprocessor produced by Intel™ of Santa Clara, Calif.), non-volatile memory (e.g., read-only memory 252), and volatile memory (e.g., random access memory 254), each of which may be interconnected via one or more data/system buses 256, 258. Personal media device 12 may also include an audio subsystem 260 for providing e.g., an analog audio signal to a audio jack 262 for removable engaging e.g., a headphone assembly 264, a remote speaker assembly 266, or an ear bud assembly 268, for example. Alternatively, personal media device 102 may be configured to include one or more internal audio speakers (not shown).

Memories 252, 254 may, for example, each comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memory may comprise other and/or later-developed types of computer-readable memory. Machine-readable firmware program instructions may, for example, be stored in memory 252. As described below, these instructions may be accessed and executed by microprocessor 250. Memory 252 may be capable of storing screen control instructions, to permit, for example, signals generated by slider device 130 to control media content items displayed on display panel/device 104, as will be described more fully below.

Personal media device 102 may also include a user interface 270 and a display subsystem 272. User interface 270 may receive data signals from various input devices included within personal media device 102, examples of which include (but are not limited to) signals generated by: rating switches 114, 116; menu switch 118; radio switch 120; backward skip switch 122; play/pause switch 124; forward skip switch 126; and slider device 130, other buttons (not shown), for example. Display subsystem 272 may provide display signals to display panel/device 104 included within personal media device 102. Display panel/device 104 may be an active matrix liquid crystal display panel, a passive matrix liquid crystal display panel, or a light emitting diode display panel, for example. Audio subsystem 260, user interface 270, and display subsystem 272 may each be coupled with microprocessor 250 via one or more data/system buses 274, 276, 278 (respectively).

Personal media device 102 may include a bus interface 280 for interfacing with e.g., a proxy computer (not shown). Personal media device 102 may include a wireless interface 282 for wirelessly-coupling personal media device 102 to one or more networks (not shown). Wireless interface 282 may be coupled with an antenna assembly 284 (for RF communication) or IR communication assembly 286 (for infrared communication) with e.g., a second personal media device (not shown).

Personal media device 102 may include mass storage device 288 for storing media data files e.g., received from a media distribution system (not shown) or ripped from a compact disc (not shown).

Storage device 288 may be, for example, a hard disk drive, an optical drive, a random access memory (RAM), a read-only memory (ROM), a CF (i.e., compact flash) card, an SD (i.e., secure digital) card, a SmartMedia card, a Memory Stick, and a MultiMedia card. Bus interface 280, wireless interface 282, and storage device 288 may each be coupled with microprocessor 250 via one or more data/system buses 290, 292, 294 (respectively).

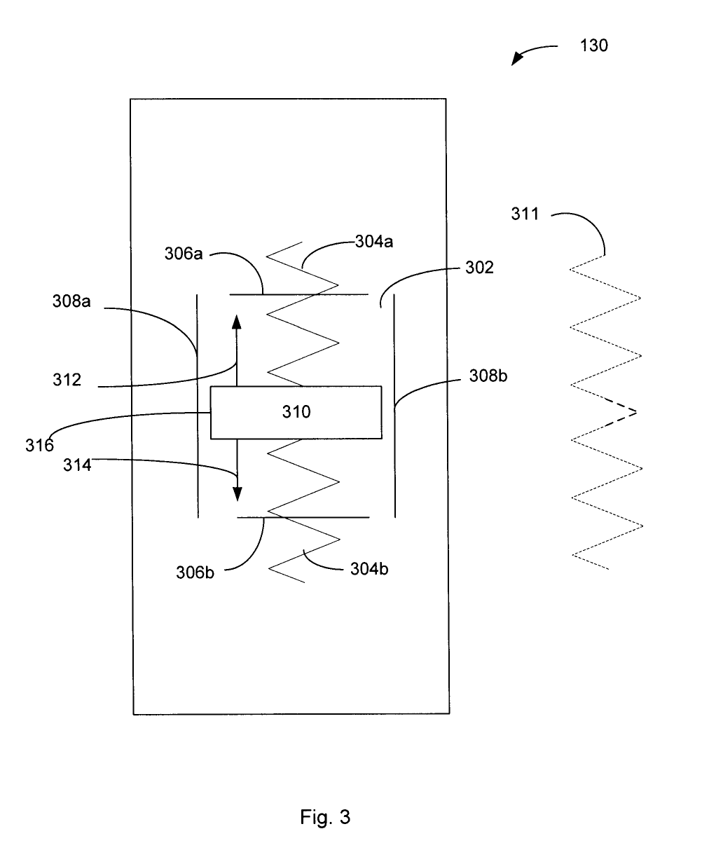

FIG. 3 depicts one exemplary slider device 130 in more detail. The slider device of this embodiment may include a tab 310 capable of moving in a first linear direction 312 and a second linear direction 314. Examples of tab 310 may include a lever, a protrusion, an extrusion, or a bulge capable of being manipulated by the user. End stops 306a and 306b may be provided to limit the movement (i.e., the distance of travel) of tab 310 in respective linear directions 312 and 314. First linear direction 312 and second linear direction 314 may be diametrically opposed (e.g., up versus down, and left versus right).

A first spring 304a may be disposed adjacent tab 310, and a second spring 304b may be disposed adjacent tab 310. In this embodiment, springs 304a and 304b are depicted as being opposed to one another, however it is equally contemplated that the springs may disposed at orientations other than depicted in FIG. 3. Spring 304a and 304b may each comprise, for example, a coil spring, a leaf spring, an elastomeric material, a resiliently deformable member, piston arrangement, and/or other spring mechanism which may be known to one skilled in the art and/or any after-developed spring mechanism, and all such alternatives are deemed equivalent to the springs 304a and 304b depicted in FIG. 3 and described herein.

Springs 304a and 304b may bias tab 310 into a biased position 316, such that when no forces are acting on tab 310 in the first or second linear directions 312 or 314, tab 310 may remain in the biased position 316. The biased position 316 may be approximately centered between end stops 306a and 306b, however, it is equally contemplated herein that static position is not centered between end stops 306a and 306b, and indeed, the biased position 306 may reside anywhere along the direction of travel of tab 310 without departing from this embodiment. Spring 304a may provide mechanical resistance to the movement of tab 310 in the first linear direction 312 (e.g., movement toward end stop 306a), and spring 304b may provide mechanical resistance to the movement of tab 310 in the second linear direction 312 (e.g., movement toward end stop 306a).

While springs 304a, 304b are described above as being separate springs, other configuration are possible and within the scope of this disclosure. For example, spring 304a may be a first portion of a main spring 311 (shown in phantom) and spring 304b may be a second portion of main spring 311.

Tab 310 may be electrically and/or mechanically coupled with an electric circuit, an example of which is planar variable resistor 302. Movement of tab 310 in relation to the planar variable resistor 302 may cause an increase or decrease of impedance (resistance) which may generate one or more signals according to the position of the tab 310, as will be described in greater detail below.

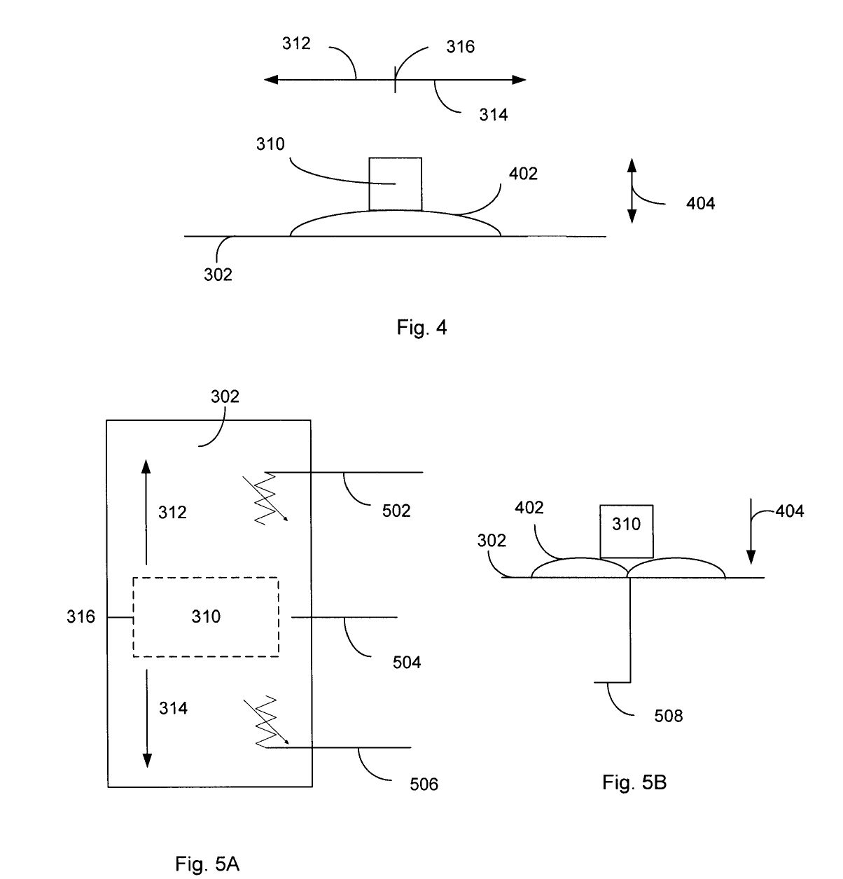

FIG. 4 depicts a side view of the exemplary slider device 130. In this embodiment, tab 310 may be capable of movement in a third linear direction 404. The third linear direction may be approximately perpendicular to the first and/or second linear directions, 312 and 314, respectively, described above with reference to FIG. 3. Here, the term “approximately” is intended to be of broad scope and may mean, for example, within engineering tolerances, or within some predetermined degree from normal (e.g., +/−45 degrees from perpendicular).

A third spring 402 may be disposed adjacent tab 310. Spring 402 may comprise, for example, a coil spring, a leaf spring, an elastomeric material, a resiliently deformable member, piston arrangement, and/or other spring mechanism which may be known to one skilled in the art and/or any after-developed spring mechanism, and all such alternatives are deemed equivalent to the spring 402 depicted in FIG. 3 and described herein.

Spring 402 may bias tab 310 into a position such that when no forces are acting on tab 310 in the third linear direction 404, tab 310 may remain positioned apart from the planar variable resistor 302, as depicted. Spring 402 may provide mechanical resistance to the movement of tab 310 in the third linear direction 404 (e.g., movement toward planar variable resistor 302). Movement of tab 310 in the third linear direction may cause planar variable resistor 302 (and/or other circuitry, not shown) to generate an electrical switch response that may generate one or more signals according to the position of the tab 310 in the third linear direction 404, as will be described in greater detail below.

FIG. 5A illustrates exemplary signals that may be generated by slider device 130. Movement of tab 310 in the first linear direction 312 may change the impedance of the planar variable resistor 302 and may cause planar variable resistor 302 to generate a first variable signal 502. Variable signal 502 may change (e.g., increase or decrease) as the position of tab 310 is moved from the biased position in the first linear direction 312. As the position of tab 310 moves back to the biased position, signal 502 may also change (e.g., increase or decrease). Similarly, movement of tab 310 in the second linear direction 314 may change the impedance of the planar variable resistor 302 and may cause planar variable resistor 302 to generate a second variable signal 506. Variable signals 502 and 506 may change linearly or logarithmically as the position of tab 310 moves from the biased position 316 in the first linear direction 312 and the second linear direction 314, respectively. However, it is equally contemplated herein that the variable signal 502, 506 may change in a non-linear fashion as tab 310 moves. When the position of tab 310 remains in the biased position 316, planar variable resistor 302 may generate a center signal 504 indicative of the tab 310 being in a the biased position.

FIG. 5B illustrates additional exemplary signals that may be generated by slider device 130. Movement of the tab 310 in the third linear direction 404 may cause the planar variable resistor 302 to switch states and may thus generate an actuation signal 508.

With continued reference to FIGS. 1 and 2, and FIGS. 5A and 5B, signals 502, 504, 506 and/or 508 may be supplied to microprocessor 250 (via, for example, analog-to-digital converter circuitry, not shown). Instructions executed by microprocessor 250 may utilize signals 502, 504, 506 and/or 508 to control scroll movement, highlighting and/or selecting/rendering of one or more items displayed on display screen 104. For example, when a user moves tab 310 upward (i.e., in the linear direction 312), signal 502 may cause media content items to scroll upward in relation to the visual indicator highlight bar 112. Similarly, when a user moves tab 310 downward (i.e., in the linear direction 314), signal 506 may cause media content items to scroll downward in relation to the visual indicator highlight bar 112. Further, when a user depresses tab 310, signal 508 may cause the media content item defined below the visual indicator highlight bar 112 to be rendered via e.g., audio subsystem 260 of personal media device 102. Additionally/alternatively, when a user depresses tab 310, signal 508 may cause a new data screen (not shown) to be rendered (on display panel/device 104) that provides the user with information concerning e.g., the media content item and/or the artist associated with the media content item; or entertains the user e.g., a screen saver and/or an animation. While in this particular example, visual highlight bar 112 is shown to be rectangular in shape, other configurations are possible and are considered to be within the scope of this disclosure. For example, visual highlight bar 112 may be square in shape or oval in shape.

As stated above, in one embodiment, as a distance of the position of tab 310 increases from the biased position in the upward or downward direction (linear direction 312, 314, respectively), movement of the media content items displayed on the display screen may increase (upwardly or downwardly) in relation to the visual indicator highlight bar 112. This may permit, for example, the scroll speed at which items are scrolled (or highlighted) on the display screen 104 to accelerate (or increase its velocity) as the position of tab 310 moves further away from the biased position. Similarly, as a distance of the position of tab 310 moves toward the biased position, the rate of the scroll speed at which items are scrolled on the display screen 104 may decelerate (or decrease its velocity). Accordingly, the user may be able to vary the rate at which data is displayed without having to e.g., repeatedly press a button to rapidly scan a long list of media tracks.

Signal 504, indicative of a biased position of the tab 310, may cause items displayed on the display screen 104 to remain stationary, and the presence of signals 502 and/or 506 may override signal 504. To select/render an item under the visual indicator highlight bar 112, tab 310 may be depressed in the third linear direction 404 to generate the actuation signal 508.

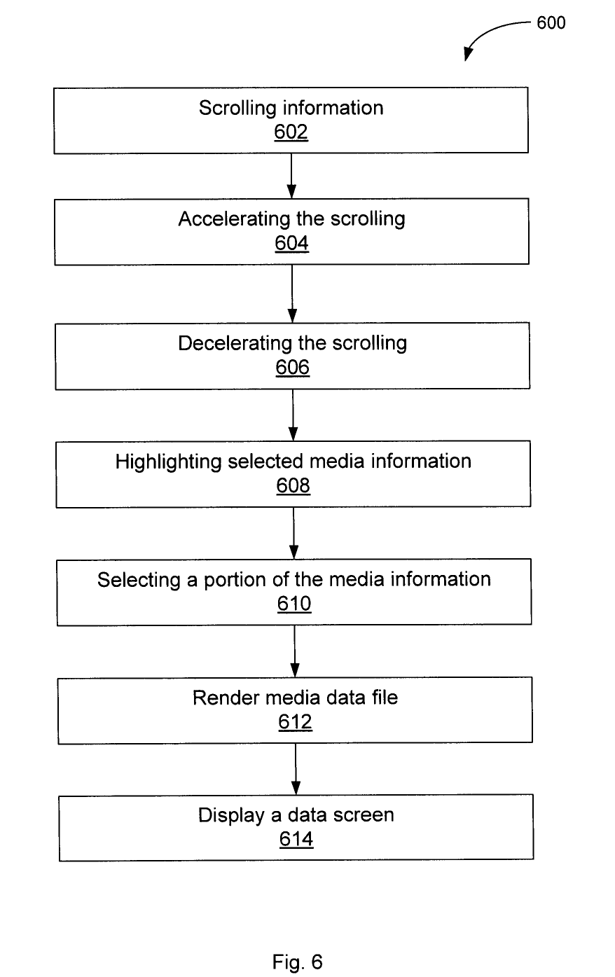

FIG. 6 depicts a flowchart 600 of exemplary operations according to one embodiment. Operations may include scrolling information 602 related to media data displayed on a display screen, in relation to a visual indicator displayed on display screen, in response to at least one variable signal indicative of movement of a slider in at least one direction. Operations may further include accelerating (or increasing the rate of) the scrolling 604 of the information related to the media data, in relation to the visual indicator displayed on the display screen, in response to a change in the at least one variable signal. Operations may further include decelerating (or decrease the rate of) the scrolling 606 of the information related to the media data, in relation to the visual indicator displayed on the display screen, in response to a change in the at least one variable signal. Operations may additionally include highlighting selected media information 608 within the visual indicator displayed on the display screen in relation to other media information displayed on the display screen, in response to a center signal indicative of a biased position of the slider. Operations may further include selecting a portion of the media information 610 within the visual indicator displayed on the display screen, in response to the actuation signal indicative of depressing the slider. Operations may further include rendering 612 a digitally encoded media data file corresponding to the selected portion of media information. Operations may further include displaying 614 on the display device a data screen corresponding to the selected portion of media information.

Thus, in summary, in at least one embodiment described herein there is provided a system that may include a personal media device capable of storing and playing media data. The personal media device may include a display screen to display information related to the media data and a slider device to permit a user to manipulate information displayed on the display screen. The slider device may include a tab capable of movement in a first linear direction and a second linear direction. The slider device may also include a first spring and second spring each disposed adjacent the tab, the first and second springs capable of biasing the position of the tab into a biased position. The first spring may be further capable of providing mechanical resistance to the movement of the tab in the first linear direction and the second spring may be further capable of providing mechanical resistance to the movement of the tab in the second linear direction. The slider device may also include a variable resistor coupled with the tab and capable of generating a first variable signal proportional to (or a function of) the distance the position of the tab is moved in the first linear direction and a second variable signal proportional to (or a function of) the distance the position of the tab is moved in the second linear direction.

While in one example, slider device 130 is described above as being an analog device, other configuration are possible and within the scope of this disclosure. For example, slider device 130 may be a digital device configured to provide a digital signal representative of the position of tab 310. More specifically, slider device 130 may be an eight-bit digital device that provides a variable digital signal that ranges from 000b to 255b depending on the position of tab 310. For example, if tab 310 is in biased position 316, a digital signal of 127b may be provided to e.g., microprocessor 250 (FIG. 2). However, when the position of the tab 310 is moved in first linear direction 312, the digital signal provided to microprocessor 250 may vary between 128b and 255b (depending on the displacement of tab 310 from biased position 316). Conversely, when the position of the tab 310 is moved in second linear direction 314, the digital signal provided to microprocessor 250 may vary between 126b and 000b (depending on the displacement of tab 310 from biased position 316).

While the system is described above as including a stationary visual indicator highlight bar 112 under which data may scroll, this is for illustrative purposes only, as other configurations are possible and within the scope of this disclosure. For example, visual indicator highlight bar 112 may be configured to move upward and downward in accordance with the displacement of tab 310.

While the system is described above as allowing the user to depress tab 310 to e.g., render the media content item defined below visual indicator highlight bar 112, other configurations are possible and considered to be within the scope of this disclosure. For example, a separate and discrete button (not shown) on personal media device 10 may be configured to allow the user to e.g., render the media content item defined below visual indicator highlight bar 112.

A number of implementations have been described. Nevertheless, it will be understood that various modifications may be made. Accordingly, other implementations are within the scope of the following claims.

What is claimed is:

1. A slider device, comprising:
a tab capable of movement in a first linear direction and a second linear direction;
a first spring and second spring each disposed adjacent the tab, the first and second springs capable of biasing the tab into a biased position, the first spring further capable of providing mechanical resistance to the movement of the tab in the first linear direction and the second spring capable of providing mechanical resistance to the movement of the tab in the second linear direction; and
an electric circuit coupled with the tab and operative to generate a first signal comprising information corresponding to a distance of movement of the tab in the first linear direction and a second signal comprising additional information corresponding to a distance of movement of the tab in the second linear direction.

2. The slider device of claim 1, wherein the first linear direction and the second linear direction are diametrically opposed.

3. The slider device of claim 1, wherein the electric circuit is operative to generate a center signal indicative of when the tab is in the biased position.

4. The slider device of claim 1, wherein the tab is further capable of movement in a third linear direction approximately perpendicular to the first linear direction or the second linear direction, wherein the slider device further comprises:
a third spring disposed adjacent the tab that is operative to bias the tab in a direction approximately perpendicular to the first linear direction or the second linear direction, and operative to provide mechanical resistance to the movement of the tab in the third linear direction.

5. The slider device of claim 4, wherein the circuit is operative to generate an actuation signal indicative of when the tab is moved in the third linear direction.

6. The slider device of claim 5, wherein the slider device is included within a personal media device, the personal media device further comprising:
a storage medium having stored thereon instructions that when executed by a processor cause the processor to perform operations comprising:
rendering, in response to the actuation signal, a digitally encoded media data file associated with media information displayed within a visual indicator of the personal media device.

7. The slider device of claim 5, wherein the slider device is included within a personal media device, the personal media device further comprising:
a storage medium having stored thereon instructions that when executed by a processor cause the processor to perform operations comprising:
displaying, in response to the actuation signal, a data screen on a display device of the personal media device.

8. The slider device of claim 1, further comprising: a first endstop disposed a predetermined distance from the tab and capable of limiting the movement of the tab along the first linear direction and a second endstop disposed a predetermined distance from the tab and capable of limiting the movement of the tab along the second linear direction.

9. The slider device of claim 1, wherein the first or second springs selected from the group consisting of a coil spring, a leaf spring, an elastic material, a resiliently deformable material and a piston.

10. The slider device of claim 1, wherein the electric circuit includes a variable resistor.

11. The slider device of claim 1, wherein the first signal is proportional to the distance of movement of the tab in the first linear direction.

12. The slider device of claim 1, wherein the second signal is proportional to the distance of movement of the tab in the second linear direction.

13. The slider device of claim 1, wherein the slider device is included within a personal media device.

14. The slider device of claim 1, wherein the first spring is a first portion of a main spring and the second spring is a second portion of the main spring.

15. A system, comprising:
a personal media device operative to store and render digitally encoded media data, the personal media device comprising a display device to display information related to the digitally encoded media data and a slider device to enable a user to manipulate an indication of the information displayed on the display device, the slider device comprising:
a tab capable of movement in a first linear direction and a second linear direction;
a first spring and second spring each disposed adjacent the tab, the first and second springs capable of biasing the tab into a biased position, the first spring further capable of providing mechanical resistance to the movement of the tab in the first linear direction and the second spring capable of providing mechanical resistance to the movement of the tab in the second linear direction; and
an electric circuit coupled with the tab and operative to generate a first signal comprising information corresponding to a distance of movement of the tab in the first linear direction and a second signal comprising additional information corresponding to a distance of movement of the tab in the second linear direction.

16. The system of claim 15, wherein the personal media device further comprising:
a storage medium having stored thereon instructions that when executed by a processor cause the processor to perform operations comprising:
moving the indication of the information related to the digitally encoded media data, in relation to a visual indicator displayed on the display device, in a first direction in response to the first signal; and
moving the indication of the information related to the digitally encoded media data, in relation to the visual indicator displayed on the display device, in a second direction in response to the second signal.

17. The system of claim 15, wherein the personal media device further comprising:
a storage medium having stored thereon instructions that when executed by a processor cause the processor to perform operations comprising:
moving a visual indicator displayed on the display device, in relation to the indication of the information related to the digitally encoded media data, in a first direction in response to the first signal; and
moving the visual indicator displayed on the display device, in relation to the indication of the information related to the digitally encoded media data, in a second direction in response to the second signal.

18. The system of claim 15, wherein the electric circuit is further capable of generating a center signal indicative of when the tab is in the biased position, and wherein the personal media device further comprises:
a storage medium having stored thereon instructions that when executed by a processor cause the processor to perform operations comprising:
highlighting, in response to the center signal, selected media information within a visual indicator displayed on the display screen in relation to other media information displayed on the display screen.

19. The system of claim 15, wherein the tab is further capable of movement in a third linear direction approximately perpendicular to the first linear direction or the second linear direction, wherein the slider device further comprises:
a third spring disposed adjacent the tab that is operative to bias the tab in a direction approximately perpendicular to the first linear direction or the second linear direction, and operative to provide mechanical resistance to the movement of the tab in the third linear direction.

20. The system of claim 19, wherein the electric circuit is further operative to generate an actuation signal indicative of when the tab is moved in the third linear direction, the personal media device further comprising:
a storage medium having stored thereon instructions that when executed by a processor cause the processor to perform operations comprising:
selecting, in response to the actuation signal, a portion of the indication of media information within a visual indicator displayed on the display screen.

21. The system of claim 19, wherein the electric circuit is further operative to generate an actuation signal indicative of when the tab is moved in the third linear direction, the personal media device further comprising:
a storage medium having stored thereon instructions that when executed by a processor cause the processor to perform operations comprising:
rendering, in response to the actuation signal, a digitally encoded media data file stored in a memory in the personal media device and associated with media information displayed within a visual indicator.

22. The system of claim 19, wherein the electric circuit is further operative to generate an actuation signal indicative of when the tab is moved in the third linear direction, the personal media device further comprising:
a storage medium having stored thereon instructions that when executed by a processor cause the processor to perform operations comprising:
displaying, in response to the actuation signal, a data screen on the display device.

23. The system of claim 15, wherein the slider device further comprising: a first endstop disposed a predetermined distance from the tab and capable of limiting the movement of the tab along the first linear direction and a second endstop disposed a predetermined distance from the tab and capable of limiting the movement of the tab along the second linear direction.

24. The system of claim 15, wherein the first and second springs are selected from the group consisting of a coil spring, a leaf spring, an elastic material, a resiliently deformable material and a piston.

25. The system of claim 15, wherein the electric circuit includes a variable resistor.

26. The system of claim 15, wherein the first signal is proportional to the distance of movement of the tab in the first linear direction.

27. The system of claim 15, wherein the second signal is proportional to the distance of movement of the tab in the second linear direction.

28. The system of claim 15, wherein the first spring is a first portion of a main spring and the second spring is a second portion of the main spring.
